(19) United States
(12) Patent Application Publication
(10) Pub. No.: US 2018/0046205 A1
(43) Pub. Date: Feb. 15, 2018

(54) Pressure Reducing Valve and A Pressure Reducing System

(71) Applicant: Beijing Huashi United Energy Technology and Development Co., Ltd., Beijing (CN)

(72) Inventors: Lin Li, Beijing (CN); Lixin Guo, Beijing (CN); Na Wang, Beijing (CN); Zhenduo Li, Beijing (CN); Yang Lu, Beijing (CN); Peipei Wang, Beijing (CN)

(73) Assignee: Beijing Huashi United Energy Technology and Development Co., Ltd., Beijing (CN)

(21) Appl. No.: 15/673,081

(22) Filed: Aug. 9, 2017

(30) Foreign Application Priority Data
Aug. 10, 2016 (CN) 201610652525.2
Sep. 23, 2016 (CN) 201610848872.2

(51) Int. Cl. G05D 16/10; F16K 1/12; F16K 11/10

(52) U.S. Cl. CPC G05D 16/106; F16K 11/105; F16K 1/12

(57) ABSTRACT

A pressure reducing valve and a pressure reducing system are provided. The pressure reducing valve includes a main valve body in which a valve chamber is formed; the main valve body is provided with a valve outlet and a valve inlet communicating with the valve chamber; and at least two pressure reducing devices adapted between the valve inlet and the valve outlet to depressurize the fluid at the valve inlet and discharge to the valve outlet. The pressure reducing valve occupies a small space, low cost and low pressure leakage point. Each pressure reducing device shares a main valve body, independent of each other, do not interfere with each other, and can be flexible to switch or use at the same time. The pressure reducing system is provided with at least one regulating member, which comprising an adjustment medium outlet section which communicates with the valve chamber through the valve body and the valve seat. Through the regulating member to reduce erosion and wear caused by the cavitation effect, and adjust the fluid flow flexibly.

### TECHNICAL FIELD

The present invention relates to the field of coal chemical and petrochemical technology, particularly relates to a pressure reducing valve and a pressure reducing system, and more particularly relates to a pressure reducing valve and a pressure reducing system that reduces pressure of a hot high-pressure separator for suspension bed hydrogenation to make it as a hot low-pressure separator

### BACKGROUND OF THE INVENTION

In the coal tar hydrogenation industry, the existing processes are like fixed bed hydrogenation, suspension bed hydrogenation and fluidized bed hydrogenation. No matter what kind of process, need to be carried after the reaction of hydrogen and part of the catalyst and other substances in the oil and gas from the high-pressure separator into the low-pressure separator, and after pressure is reduced, to achieve gas-liquid separation.

In the above mentioned pressure reducing occasions, the differential pressure from the high pressure separator to the low pressure separator can be 5 MPa to 100 MPa, and the hydrogenated reduced pressure medium may be a liquid, gas-liquid mixture or a gas-liquid three-phase mixture. The pressure of the liquid at the cross section of the valve is reduced to equal to or lower than the saturated vapor pressure of the liquid at the valve inlet temperature, and some of the liquid is vaporized and produced a flashing phenomenon. At the same time, the pressure reducing process results in the partial release of dissolved hydrogen in the fluid, and the partial fluid pressure after the reducing section is restored to its saturated vapor pressure, causing the vaporized liquid to recover to the liquid phase, the bubble burst, and the energy released to produce cavitation phenomenon, while also generating vibration and noise. The flash phenomenon and cavitation will damage the valve core, valve seat and the valve chamber inner wall, resulting in short valve life, usually in a week to three months. However, these pressure reducing valves are located between the high and low pressure system in the oil and hydrogenation industry, which located in the most important part of the device. Pressure reducing valve must ensure stable and continuous operation in order to maintain the smooth operation of production.

At present, the commonly used pressure reducing valve adopted a set of valve core-valve seat cooperate structure within a single valve chamber. Such as the Chinese patent CN201351763 discloses a high pressure differential pressure reducing valve, through the thread and the pin and the valve rod which fixed connecting to valve core drives the valve core to move up and down in the valve seat, the valve core uses a tapered structure with a gradually decrease in diameter, and has a bushing and an orifice plate at the lower part of the valve seat. Through the above high pressure differential pressure reducing valve to reduce the damage cause to the valve body by the high pressure fluid, and can be used to transport the media containing solid particles.

In the prior art pressure reducing valve, because of there is only one set of valve seat seats in the valve chamber when facing the high pressure and high solid content medium, if the valve core is damaged in operation, it is often necessary to replace it to continue the work, it is still difficult to meet the practical work of the need for stable and continuous operation.

In order to solve the above technical problems, usually in the actual production process, the need for two or more of the pressure reducing valve would be necessary for spare to each other, each spare pressure reducing valve's front and rear would each need to equip a high-pressure manual valves and drain valve in order for isolating the pressure reducing valve with the front and rear process pipeline during maintenance, and also need to configure the corresponding front and rear high-pressure pipeline. As disclosed in Chinese Patent CN 204752627 U, a pressure reducing system that reduces pressure of a hot high-pressure separator for suspension bed hydrogenation to make it as a hot low-pressure separator. The pressure reducing system is provided with a plurality of sets of pressure reducing devices, each of which is provided with a plurality of circuit pressure reducing valve sets to achieve a pressure reducing process for changing a hot high-pressure separator into hot low-pressure separator, the circuit pressure reducing valve sets comprise an angle valve, a ball valve and a pressure reducing valve successively. Between the outlet of the angle valve and the inlet of the ball valve, and between the outlet of the ball valve and the inlet of the pressure reducing valve are respectively connected with a pipe, and the outlet of the pressure reducing valve is connected with a corresponding feed inlet of the low-pressure separator. Through the setup of multiple sets of pressure reducing device, when one set is under maintenance, it can switch to another set to achieve long-term operation; Moreover, by setting up plurality of circuit pressure reducing valve at each set of a pressure reducing device, the device is able to use simultaneously or separately.

However, when the above-mentioned circuit pressure reducing valve set is provided with an angle valve, a ball valve and a pressure reducing valve successively, and also provided with a plurality of high-pressure pipelines, a possibility of leakage would occur at the connection between high-pressure pipelines and valves, as well as connection between high-pressure pipelines and other parts when under the high temperature and high pressure environment, thereby increasing the high-pressure leakage point, and meanwhile, the valves and the high-pressure pipelines, as backup pressure reducing valves and its pipelines would occupy a lot of space, thereby increasing the cost of equipment.

In addition, the pressure reducing system in the above-mentioned can effectively ensure the stable operation of the pressure reducing system, and through the setup of an angle valve, a ball valve, and a pressure reducing valve successively to form a set of pressure reducing valves will able to achieve the pressure reducing purpose for changing hot high-pressure separator into hot low-pressure separator. However, when facing high temperature, high pressure, and high solid content fluid, valve core and valve seat inside the successively provided angle valve, ball valve and pressure reducing valve will suffer a serious erosion and wear by the fluid, especially in the pressure reducing valve. Also the pipeline connected to the valve body would suffer the corresponding erosion and wear as well; Further, the above-mentioned high temperature, high pressure, and high solid content fluid has a condition of forming a blocking flow in the valve body, and would resulting in the above-mentioned pressure reducing valve sets not effectively adjust the fluid flow.

### SUMMARY OF THE INVENTION

For this reason, one of the technical problems to be solved by the present invention is that the reduced pressure structure used in prior art's high pressure drop pressure reducing system occupies a large space, with a high cost and has plurality of high pressure leakage point, so thereby by providing a pressure reducing valve that has less high pressure leakage point, occupies a smaller space, and at low cost would solve the problem.

In order to solve the above technical problems, the technical scheme adopted by the invention is as follows:

According to one aspect of the present invention, a pressure reducing valve is provided which comprising
a main valve body, having a valve chamber formed therein, and also having a valve outlet and a valve inlet which are disposed thereon and respectively communicated with the valve chamber; characterized in comprising
at least two pressure reducing devices, disposed between the valve inlet and the valve outlet, and adapted for depressurizing fluid at the valve inlet before discharging to the valve outlet.

Preferably, the pressure reducing device comprises
a branch valve body, connected to the main valve body,
a branch valve chamber formed in the branch valve body and in communication with the valve chamber, and
a valve core, slidably disposed in the branch valve chamber for regulating flow rate or closing a fluid passage between the valve inlet and the valve outlet. Preferably, the main valve body is integrally formed with the branch valve body.

Further, the branch valve chamber formed with a flow reducing section and a flow increasing section, the flow reducing section is communicated with the valve inlet, the flow increasing section is communicated with a smaller opening end of the flow reducing section, and a larger opening end of the flow increasing section is communicated with the valve outlet.

Preferably, the flow increasing section and the flow reducing section are both arranged in a tapered section, and the cone vertex of the flow increasing section is in coaxial communication with the cone vertex of the flow reducing section.

Preferably, the flow reducing section has a decrease of inner diameter in the flow direction of the fluid; and the flow increasing section has an increase of inner diameter in the flow direction of the fluid.

Preferably, the branch valve body comprises a body having a tubular passage formed therein, and a valve seat is disposed coaxially in the tubular passage close to one side of the valve outlet, an inner cavity of the valve seat comprises the smaller opening end of the flow reducing section and the flow increasing section which cooperate with a remaining section of the tubular channel to form the branch valve chamber, wherein, the valve core is slidable within the tubular passage and a movable end of the valve core cooperates with the smaller opening end of the flow reducing section for regulating the flow or closing the fluid passage.

Preferably, the valve seat is arranged to cause the branch valve chamber to form a flow reducing section and a flow increasing section.

Preferably, pressure reducing valve further comprises an adjustment mechanism detachably connected to the valve core, wherein, the adjustment mechanism is adapted for driving the valve core to slide axially along the branch valve chamber to adjust a gap formed between the valve core and the valve seat for regulating fluid flow.

Preferably, the adjusting mechanism is connected with a valve rod, and the valve rod is detachably connected with the valve core.

Preferably, an axis of the branch valve chamber and an axis of the valve outlet intersect to form an angle α of 5° to 30°, preferably 8° to 15°, and most preferably 10°, and axes of each two adjacent branch valve chambers intersect to form an angle β of 10° to 60°, preferably 16° to 30°, and most preferably 20°.

Preferably, the pressure reducing valve further comprises an inlet flow passage communicated with the valve inlet, with an axis of the inlet flow passage being perpendicular to an axis of the valve outlet, and an outlet flow passage communicated with the pressure reducing device and the valve outlet; wherein, the ratio of the inner diameter of the outlet flow passage to the inner diameter of the inlet flow passage is greater than one, preferably 2 to 10, and most preferably 3.

Preferably, the valve core and the branch valve chamber also have a guide sleeve disposed therebetween, and the valve core is slidable within the guide sleeve in a sealed manner.

Further, the branch valve chamber, the guide sleeve, and the valve core are provided coaxially.

Preferably, an inner surface of the outlet flow passage and the branch valve body, an outer surface of the valve core, and an inner wall of the inner cavity of the valve seat are respectively provided with a wear layer.

Preferably, the pressure reducing valve further comprises a sealing section which filling a gap between the valve core and the guide sleeve to axially seal the gap; sealing gasket for sealing the gap between the tubular passage and coaxially fitted around the valve seat within the tubular passage.

The axis described in the present invention are generally directed to tubular structures, but other configurations with bus bars are also applicable.

In addition, another technical problem to be solved by the present invention is that in the prior art's pressure reducing system for high temperature, high solid content, and high pressure differential fluid has a defect that the valve core and valve seat are eroded and worn, and the fluid flow rate adjustment is stiff. Therefore, it needs to provide a pressure reducing system for using in high temperature, high solid content, and high pressure differential fluid that has a valve core and valve seat with low erosion and wear, and flexible fluid flow adjustment.

As another aspect of the present invention, a pressure reducing system is provided, which comprises a high pressure separator, a low pressure separator, and at least one pressure reducing member disposed between the high pressure separator and the low pressure separator.

Preferably, the pressure reducing component comprises at least one pressure reducing member including a valve body, a valve chamber formed in the valve body, a valve seat provided in the valve chamber, and a valve core extending into the valve chamber and cooperating with the valve seat to adjust the size of the fluid passage,

Preferably, the pressure reducing member further comprises at least one regulating member including an adjustment medium outlet section, through which the valve body and the valve seat are communicated with the valve chamber.

Preferably, the regulating medium outlet section is inclined toward a flow direction of the fluid, and an outlet end of the regulating medium outlet section is provided on the valve seat adjacent to the valve core.

Preferably, the adjusting member further comprises a second flush valve in communication with the regulating medium outlet section.

Preferably, the regulating medium is asphaltenes and the temperature of the asphaltenes is 180° C. to 220° C., and the pressure of asphaltene in the adjusting member is 20 bar to 30 bar, and the ratio of the regulating medium to the flow rate from the heat score in the high pressure separator is (0.8-1.2):10.

Preferably, the pressure reducing member further comprises an inlet section communicating with an inlet of the pressure reducing member and an outlet section communicating with an outlet of the pressure reducing member, which along the flow direction of the fluid, and wherein the inner cavity of the valve seat comprises a flow reducing section and a flow increasing section, a movable end of the valve body cooperates with the flow reducing section for regulating the flow rate or closing the fluid passage.

Preferably, an axial direction of the outlet section of the pressure reducing member is set to be perpendicular to an axial direction of the inlet section of the pressure reducing member, the outlet section and the low pressure separator intersect to form an axial angle γ of 70° to 80°, and the ratio of diameters of the inlet section and the outlet section is not great than 0.5.

Preferably, the pressure reducing component comprises more than two pressure reducing members, and more than two regulating members, wherein, the regulating members are arranged to respectively correspond to respective one of the pressure reducing members, the pressure reducing member and the high pressure separator has a diversion valve disposed therebetween, the diversion valve comprises at least one inlet and more than two outlets, and the outlets are arranged to respectively correspond to respective one of the pressure reducing members.

Preferably, the low pressure separator comprises at least one hot low-pressure separator inlet section which communicates with the low pressure separator inner cavity and being disposed obliquely on the low pressure separator. The hot low-pressure separator inlet section and the low pressure separator intersect to form an axial angle γ of 70° to 80°.

Preferably, a first stop valve is disposed between the outlet and the pressure reducing member.

Preferably, the pressure reducing system further comprises a second stop valve, an inlet of which is in communication with an outlet of the pressure reducing member, while an outlet of which is in communication with the low pressure separator, wherein, an outlet section of the pressure reducing member, the second stop and a low heat inlet section if the low pressure separator are disposed coaxially.

The adjacent two hot low-pressure separator inlet sections intersect to form an angle not greater than 60°, and the outlet of the first stop valve is in direct communication with the inlet of the pressure reducing member.

Preferably, the pressure reducing system further comprises a first flush valve communicated with the diversion valve to flush impurities within the diversion valve; the thermal barrier coating and the wear resistant coating, successively disposed on a connecting pipe between the high pressure separator and the pressure reducing member, an inner wall of the connecting pipe between the pressure reducing member and the low pressure separator, and an inner wall of the low pressure separator.

Preferably, the pressure reducing member is the pressure reducing valve.

Compared with the prior art, the invention has the following beneficial effects:

1. According to one embodiment of the present invention, a pressure reducing valve is provided, in which at least two pressure reducing devices are disposed between the valve inlet and the valve outlet, and adapted for depressurizing fluid at the valve inlet before discharging to the valve outlet. Through the above settings, the valve will be caused to occupy a smaller space, lower cost and less high pressure leakage points.
2. In the pressure reducing valve of the embodiments of the present invention, at least two pressure reducing devices provided are adapted for depressurizing fluid at the valve inlet before discharging to the valve outlet, each of the pressure reducing device shares a main valve body, and these reducing devices are independent of each other and do not interfere with each other, and are able to be flexibly switched or used simultaneously.
3. In the pressure reducing valve of the embodiments of the present invention, an axis of the branch valve chamber and an axis of the valve outlet intersect to form an angle α of 5° to 30°, which causes the fluid exiting from the symmetrical branch valve chamber would converge at the center line of the valve outlet to form a eddy current, so as to result in fluid collision and produce heat. This will consume the pressure and speed of the fluid after the pressure is reduced, so as to minimize the erosion and cavitation caused by the decompressed high-speed fluid to the pressure reducing valve; the axes of each two adjacent branch valve chambers intersect to form an angle β of 10° to 60°, which facilitate the fluid to converge at the center line of the valve outlet to form eddy current, so as to cause fluid collision and produce heat. The diameter of the outlet is enlarged by setting the ratio of the inner diameter of the outlet section and the diameter the inlet flow passage to be greater than 1, which helps to reduce the speed of the decompressed fluid, and reduce the erosion and wear caused by the fluid to the outlet flow passage.
4. In the pressure reducing valve of the embodiments of the present invention the axis of the inlet flow passage is set to be perpendicular to the axis of the valve outlet, so as to ensure that the fluid entrance direction is perpendicular to the axis of the valve outlet and significantly prevent high pressure fluid from wearing the pressure reducing valve, for example, erosion to the valve core and the valve seat. Meanwhile, the above-mentioned setting has a self-cleaning function for the solid content fluid to prevent the solid particles from accumulating in the valve chamber, thereby preventing the solid particles accumulated in the valve chamber from coking at high temperature and clogging the flow passage, or damaging the sealing surface between the valve core and the valve seat; the above-mentioned setting also gives enough space to design a plurality of branch valve chambers.
5. In the pressure reducing valve of the embodiments of the present invention, the pressure reducing device includes a branch valve body connected to the main valve body, and the branch valve chamber is formed within the branch valve body to connect with the valve chamber, and the valve core is slidably disposed in the branch valve chamber for regulating flow rate or closing a fluid passage between the valve inlet and the valve outlet. The branch valve body further comprises a body having a tubular passage formed therein, and a valve seat is disposed coaxially in the tubular passage close to one side of the valve outlet, an inner cavity of the valve seat comprises the smaller opening end of the flow reducing section and the flow increasing section which cooperate with a remaining section of the tubular channel to form the branch valve chamber, wherein, the valve core is slidable within the tubular passage and a movable end of the valve core cooperates with the smaller opening end of the flow reducing section for regulating the flow or closing the fluid passage. Therefore, it is possible to design several sets of the valve core and valve seat of different sizes and the corresponding fluid passages thereto, in order to achieve no disturbance switch between different fluxes, so that it is more flexible and convenient. It also provides more selectivity and operability during the production, and meets the requirements of different processes, especially adapted to the conditions of blocking flow.
6. In the pressure reducing devices of the embodiments of the invention, the pressure reducing devices are independent of each other, and even if one of the pressure reducing devices has a problem, the use of the other pressure reducing devices will not be affected. Moreover, the sealing between the valve core and the guide sleeve is tight, the main valve body flow passage design has no dead corners, so there is no solid particles deposition and coking phenomenon.
7. In the pressure reducing system of the embodiments of the invention, at least one regulating member are provided, which includes an adjustment medium outlet section through which the valve body and the valve seat communicate with the valve chamber. The outlet end of the adjustment medium outlet section is arranged on the valve seat, which introduces the adjustment medium into the top end of the inner cavity of the valve seat and the valve core in order to raise the pressure at this point, so as to migrate the tendency that the pressure at this point stays lower than the pressure of the saturated vapor pressure of the fluid, during the process of during the rapid fluid decompression, and reduce the level of erosion and wear to the valve core and the valve seat due to bubble burst and cavitation caused by the cavitation phenomenon; and the proportion of the adjustment medium and fluid is regulated to prevent the pressure reducing member from losing the ability to adjust the fluid flow due to the formation of blocking flow caused by high temperature, high pressure, and high solid content fluid.
8. In the pressure reducing system of the embodiments of the invention, the regulating medium outlet section is inclined toward the direction of the fluid, which forms convection with the fluid, and reduces its erosion and wear to the valve core and the valve seat. The outlet end of the regulating medium outlet section is provided near on the valve seat of the valve core, which can reduce the level of erosion and wear toward the top end of the valve core caused by the fluid, slow down the flow rate of the fluid, and thereby reducing the level of erosion and wear toward the subsequent valve seat caused by the fluid.
9. In the pressure reducing system of the embodiments of the present invention, the regulating medium is asphaltenes and the temperature of the asphaltenes should control from 180° to 220° C., which imparts an appropriate viscosity to the asphaltenes. When asphaltenes is mixed with the fluid, it is capable of adsorbing the catalyst particles in the fluid to cause the surface of the hard catalyst particles to be covered by the asphaltene, thereby slowing the erosion caused by the rapid scour toward the valve core and the valve seat; the pressure of the regulating medium in the adjustment member is 20 Bar to 30 bar, and the flow rate ratio of the regulating medium to the hot high-pressure separator in the high pressure separator is (0.8-1.2):10, which can flexibly regulate the hot high-pressure separator flow rate.
10. In the reduced pressure system of the embodiments of the present invention, the outlet section and the low pressure separator intersect to form an axial angle γ of 70° to 80°, which prevents the solid from being deposited and coked in the pipeline, and the fluid diffuses by relying on its tilted impact force and contacts the bottom medium of the low pressure separator to create a perturbation to the bottom medium, and to prevent solid from being deposited and coking in the bottom media; meanwhile, it also slows down the level of impact caused by the fluid to the internal of the low pressure separator and extends the service cycle of the low pressure separator.
11. In the reduced pressure system of the embodiment of the present invention, a stop valve is arranged to directly connect with the inlet of the pressure reducing member, so that the stop valve can be utilized to control the fluid; meanwhile, the direct connection between the stop valve and the pressure reducing member, without an intermediate pipe disposed, may not cause the problem that solid particles sour and block the pipeline due to coking therein.

### BRIEF DESCRIPTION OF THE DRAWINGS

In order to illustrate the specific embodiments of the invention or the technical solutions in the prior art more clearly, the following drawings, which are intended to be used in the description of the specific embodiments or the prior art, will be briefly described, and it will be apparent that the following description of the drawings are some of the embodiments of the present invention, and other drawings may be obtained by those skilled in the art without departing from the inventive work.

FIG. 1 is an external view of a pressure reducing valve as in the embodiment of the present invention;

FIG. 2 is a cross-sectional view of a pressure reducing valve according to an embodiment of the present invention;

FIG. 3 is a schematic structural view of a pressure reducing system as described in the embodiment of the present invention.

FIG. 4 is a schematic structural view of a pressure reducing member according to an embodiment of the present invention.

FIG. 5 is a schematic structural view showing a connection structure between a pressure reducing member and a low pressure separator according to an embodiment of the present invention.

FIG. 6 is another schematic structural view of the pressure reducing system according to an embodiment of the present invention.

### DESCRIPTION OF THE REFERENCE SIGNS IN THE DRAWINGS

1—High pressure separator; 2—First pipeline; 3—Diversion valve; 4—First stop valve; 5—Pressure reducing component; 5-1—Valve inlet; 5-2—Valve outlet; 5-3—Main valve body; 5-4—Valve core; 5-5—Guide sleeve; 5-6—Top thread; 5-7—Valve seat; 5-8—Connecting bolt; 5-9—Sealing section; 5-10—Sealing gasket; 5-11—Wearing layer; 5-12—Outlet section; 5-13—Adjustment mechanism; 5-14—Valve rod; 5-15—Inlet section; 6—Second pipeline; 7—Second stop valve; 8—Low pressure separator; 9—First flush valve; 10—Second flush valve; 11—Adjustment member; 11-1—Regulating medium outlet section; 12—Hot low-pressure separator inlet section; 13—Hydraulic turbine device; 14—Clutch; 15—Motor; 16—Transmission; 17—High-pressure pump; 18—Flowmeter; 19—First control valve; 20—Second control valve.

### DETAILED DESCRIPTION OF EMBODIMENTS

In order to better illustrate the objection, technical solutions and advantages of the present invention, the present invention will be described in further detail with reference to specific embodiments thereof. The invention may be embodied in many different forms and should not be construed as limited to the embodiments set forth herein. Rather, these embodiments are provided so that the disclosure will be thorough and complete, and will fully convey the teachings of the invention to those skilled in the art, and the invention will be limited only by the claims.

In the description of the present invention, the terms “center”, “upper”, “lower”, “left”, “right”, “vertical”, “horizontal”, “internal”, “external” indicated the direction or positional relationship is the direction or positional relationship based on the drawings. It is only for ease of description of the present invention and for simplicity of description, rather than to indicate or imply that the device or element referred to must have a specific orientation in a particular orientation construction and operation, and therefore can not be construed as limiting the present invention. In addition, the terms “first”, “second”, and “third” are used for descriptive purposes only and are not to be construed as indicating or imposing relative importance.

In the description of the present invention, the terms “install”, “join”, “connect” should be broadly understood, unless otherwise specified and defined, for example, a fixed connection or a removable connected, or integrally connected; can be mechanical or electrical connection; The connection can be direct connection or indirect connection through an intermediary, and the connection can also be the internal communication between two components. It will be apparent to those skilled in the art that the specific meaning of the above terms in the present invention may be understood in particular.

In addition, the technical features described in the different embodiments of the present invention described below may be combined with each other as long as they do not constitute a conflict with each other.

### Embodiment 1

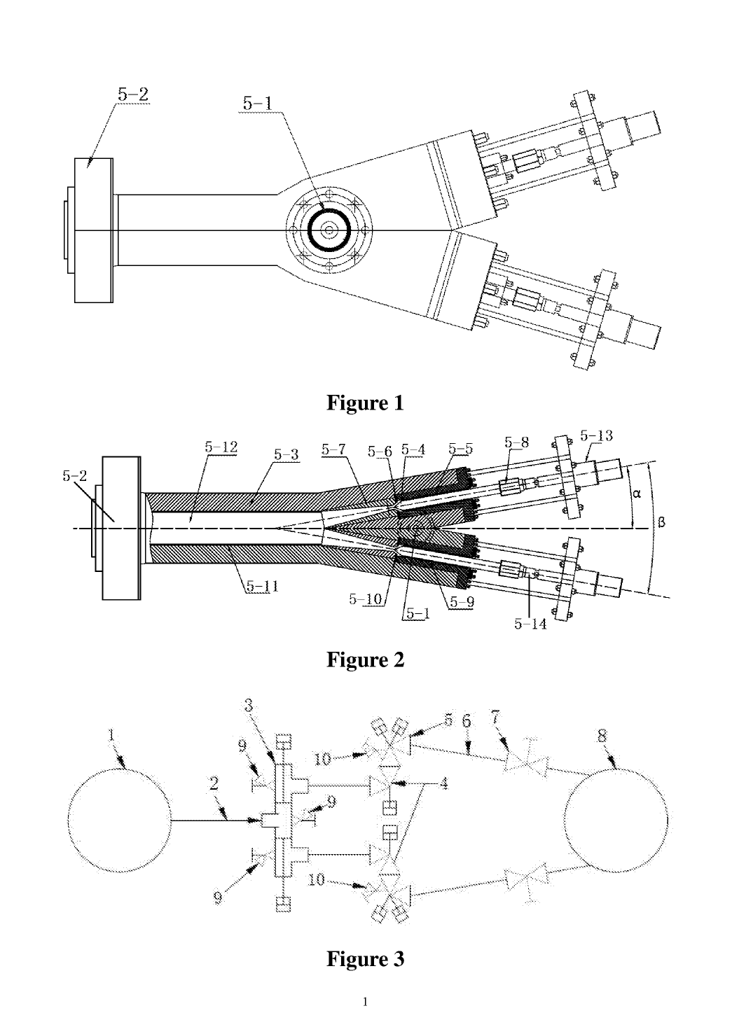

The present invention provides a pressure reducing valve, illustrated in FIGS. 1 and 2, which comprises a main valve body 5-3, having a valve chamber formed therein, and also having a valve outlet 5-2 and a valve inlet 5-1 which are disposed thereon and respectively communicated with the valve chamber; comprises at least two pressure reducing devices, disposed between the valve inlet 5-1 and the valve outlet 5-2, and adapted for depressurizing fluid at the valve inlet 5-1 before discharging to the valve outlet 5-2. In the present embodiment, there are two (2) pressure reducing devices; in other embodiments, there can be three or more pressure reducing devices. In the present embodiment, there is one valve inlet 5-1 and one valve outlet 5-2.

In the pressure reducing valve provided above, the configuration only occupies a small space, and may have low cost and less high pressure leakage point. The pressure reducing devices share one main valve body, which are independent of each other and do not interfere with each other, and are also able to be flexibly switched or used simultaneously; meanwhile, it is able to prevent a plurality of high-pressure hand valves, a plurality of sewage hand valves, and a plurality of high-pressure pipelines being parallel arranged as provided in the prior art.

|On the basis of the above-mentioned technical scheme, the pressure reducing device also comprises a branch valve body connected to the main valve body 5-3, a branch valve chamber formed in the branch valve body in communication with the valve chamber, and a valve core 5-4 slidably disposed in the branch valve chamber for regulating flow rate or closing a fluid passage between the valve inlet 5-1 and the valve outlet 5-2. In the present embodiment, there are two branch valve chambers; in other embodiments, there can be three or more branch valve chambers.

Preferably, the main valve body 5-3 is integrally formed with the branch valve body.

On the basis of the above-mentioned technical scheme, the branch valve chamber is formed with a flow reducing section and a flow increasing section, the flow reducing section is communicated with the valve inlet 5-1, the flow increasing section is communicated with a smaller opening end of the flow reducing section, and a larger opening end of the flow increasing section is communicated with the valve outlet 5-2.

Preferably, the flow increasing section and the flow reducing section are both arranged in a tapered section, and a cone vertex of the flow increasing section is in coaxial communication with a cone vertex of the flow reducing section.

Preferably, the branch valve body comprises a body having a tubular passage formed therein, and a valve seat 5-7 is disposed coaxially in the tubular passage close to one side of the valve outlet 5-2, an inner cavity of the valve seat 5-7 comprises the smaller opening end of the flow reducing section and the flow increasing section which cooperate with a remaining section of the tubular channel to form the branch valve chamber, wherein, the valve core 5-4 is slidable within the tubular passage and a movable end of the valve core 5-4 cooperates with the smaller opening end of the flow reducing section for regulating the flow or closing the fluid passage.

Through the above configuration, it is possible to design several sets of the valve core and valve seat of different sizes and the corresponding fluid passages thereto, in order to achieve no disturbance switch between different fluxes, so that it is more flexible and convenient. It also provides more selectivity and operability during the production, and meets the requirements of different processes, especially adapted to the conditions of blocking flow.

On the basis of the above-mentioned technical scheme, the adjustment mechanism 5-13 is detachably connected to the valve core 5-4, wherein, the adjustment mechanism is adapted for driving the valve core 5-4 to slide axially along the branch valve chamber to adjust a gap formed between the valve core 5-4 and the valve seat 5-7 for regulating fluid flow. In the present embodiment, the adjustment mechanism 5-13 may be in the form of a hydrodynamic form; in another embodiments, it may be in the form of a pneumatic, an electric or a manual form, each of which mentioned above is an operation known to those skilled in the art, which will not repeat again. In the present embodiment, the valve core 5-4 and the adjustment mechanism 5-13 are connected through a valve rod 5-14. One end of the valve core 5-4 is connected to the valve rod 5-14 by a bolt for easy replacement, and the other end of the valve rod 5-14 is detachably connected to the adjustment mechanism 5-13, and the adjustment mechanism 5-13 is adapted for driving the valve rod 5-14, thereby causing the valve core 5-4 to slide axially along the branch valve chamber, so that a gap between the valve core 5-4 and the valve seat 5-7 is formed to regulate fluid flow.

Preferably, the valve rod 5-14, the valve core 5-4, and the valve seat 5-7 are provided coaxially.

On the basis of the above-mentioned technical scheme, the axis of the branch valve chamber and an axis of the valve outlet 5-2 intersect to form an angle α of 5° to 30°, preferably 8° to 15°. Based on the above configuration, the fluid exiting from the symmetrical branch valve chamber would converge at the center line of the valve outlet, to form a eddy current, so as to result in fluid collision and produce heat. This will consume the pressure and speed of the fluid after the pressure is reduced, so as to minimize the erosion and cavitation caused by the decompressed high-speed fluid to the pressure reducing valve.

On the basis of the above-mentioned technical scheme, the axes of each two adjacent branch valve chambers intersect to form an angle β of 10° to 60°, preferably 16° to 30°, which facilitate the fluid to converge at the center line of the valve outlet to form eddy current, so as to cause fluid collision and produce heat.

On the basis of the above-mentioned technical scheme, the pressure reducing valve also comprises an inlet flow passage communicated with the valve inlet 5-1, with an axis of the inlet flow passage being perpendicular to an axis of the valve outlet 5-2, so as to ensure that the fluid entrance direction is perpendicular to the axis of the valve outlet 5-2 and significantly prevent high pressure fluid from wearing the pressure reducing device, for example, erosion to the valve core 5-4 and the valve seat 5-7; Meanwhile, the above-mentioned setting has a self-cleaning function for the solid content fluid to prevent the solid particles from accumulating in the valve chamber, thereby preventing the solid particles accumulated in the valve chamber from coking at high temperature and clogging the flow passage, or damaging the sealing surface between the valve core 5-4 and the valve seat 5-7; the above-mentioned configuration also gives enough space to design a plurality of branch valve chambers.

On the basis of the above-mentioned technical scheme, the pressure reducing valve comprises an outlet section 5-12 communicated with the pressure reducing device and the valve outlet 5-2; The diameter of the outlet is enlarged by setting the ratio of the inner diameter of the outlet section 5-12 and the diameter of the inlet flow passage to be greater than 1, which helps to reduce the speed of the decompressed fluid, and reduce the erosion and wear caused by the fluid to the outlet section 5-12.

On the basis of the above-mentioned technical scheme, a guide sleeve 5-5 is also provided between the valve core 5-4 and the branch valve chamber, and the valve core 5-4 is adapted to seal slide within the guide sleeve.

Preferably, the branch valve chamber, guide sleeve, and the valve core are provided coaxially.

A wearing layer 5-11 is provided on the inner surface of the outlet section 5-12 and the branch valve chamber, on the outer surface of the valve core 5-4 and on the inner wall of the inner cavity of the valve seat 5-7. In the present embodiment, the wearing layer 5-11 can be formed by high temperature spraying to ensure adequate hardness and strength, which is compared to the traditional use of bead welded Stellite alloy or internal shell method, which is more erosion and wear resistance, as well as has longer life in use.

Further, the valve seat 5-7 and valve core 5-4 are provided coaxially.

Of course, it should be noted that the structure of the valve seat 5-7 and the valve core 5-4 may also be selected from other structures known to those skilled in the art, such as for a solid high pressure differential condition, the valve core end face should adopt a plunger shape or a parabolic shape; when facing non-solid high pressure differential condition, according to the pressure drop condition, it is possible to use a single valve core or multi-stage depressurization valve core, in order to prevent the flash and cavitation, and extend the service life of the valve, the detailed structure which will not repeat again here.

Preferably, the pressure reducing valve further comprises a sealing section 5-9 for filling a gap between the valve core 5-4 and the guide sleeve to axially seal the gap. In the present embodiment, the sealing section 5-9 can be the material for filling the gap between the valve core 5-4 and the guide sleeve 5-5.

The pressure reducing valve further comprises a sealing gasket for sealing the gap between the tubular passage and coaxially fitted around the valve seat 5-7 within the tubular passage. In the present embodiment, the sealing gasket 5-10 can be the graphite spiral wound gasket.

On the basis of the above-mentioned technical scheme, the process pipeline and the valve inlet 5-1 or the valve outlet 5-2 may be connected by means of various means such as flange connection, Grayloc connection or welding, etc. In the present embodiment, the flange connection is adopted; Similarly, when the outlet section 5-12 is connected to other pipelines, any of the above-described various connection methods may be used.

In addition, it should be noted that the flow increasing section of the valve seat 5-7 is a tapered area for the role to buffer the decompression, the inner wall of the flow increasing section is sprayed with special hardening materials, forming a wearing layer 5-11, which increases the level of erosion resistance; a hard sealing is adopted between the valve seat 5-7 and the valve core 5-4, the smaller opening end of the flow reducing section of the valve seat 5-7 is axial fixed by the guide sleeve 5-5, the radial direction of the flow reducing section of the valve seat 5-7 is radially fixed to the guide sleeve 5-5 through a top thread 5-6, and the end surface of the top thread 5-6 is fixed into a fixing groove of the flow reducing section of the valve seat 5-7 which is close to the inner wall of the valve body 5-3. The valve seat 5-7 and the valve core 5-4 are axially aligned to seal the gap between the guide sleeve 5-5 and the adjacent end of the valve seat 5-7, and to seal the gap between the guide sleeve 5-5 and the inner wall of the branch valve chamber through the sealing gasket 5-10, in order to prevent the fluid from leaking out.

The fluid flows through a common inlet flow passage into the separate branch valve chamber, and then converge at the outlet section 5-12 through the pressure reducing device, to complete the decompression process. By taking the above pressure reducing valve to use in the pressurize process for hot high-pressure separator and hot low-pressure separator, the process is as follows: hot high-pressure separator is the material produced after the coal tar hydrogenation reaction of the suspended bed, wherein the elements include the oil after the reaction, the incomplete-reacted coal tar, hydrogen and catalyst, which have a solid content of up to 15 wt %, a pressure of up to 20 MPa, and a temperature of 410° C. By using the above materials in a pressure reducing process, through the fluid level signal of the hot high-pressure separator, the pressure reducing valve in the present embodiment utilizes its adjustment mechanism 5-13 to drive the valve core 5-4 together by controlling the valve rod 5-14. The above-mentioned material enters the branch valve chamber through the inlet flow passage, and the flow rate of the material is controlled by changing of the gap between the valve core 5-4 and the valve seat 5-7, through which the material passes, so that the liquid level stability can be ensured. The opening position of the single valve is at 8%-30%, the flow rate is maintained between 3000 kg/h and 7000 kg/h. After the pressured is reduced, the pressure of the hot low-pressure separator is 0.8 MPa. Under the working condition of high temperature, high pressure, and high solid content, it is easier to disassemble for maintenance, has better wear resistance and higher usability; The pressure reducing valve in the prior art such as in Chinese patent CN201351763 disclosed the life of a high pressure differential pressure reducing valve is from 50h to 168h, and the life of the pressure reducing valve of the present invention is from 800h to 2500h.

### Embodiment 2

The embodiment of the present invention provides a pressure reducing system, as shown in FIGS. 3, 4 and 5, comprising a high pressure separator 1, a low pressure separator 8, and at least one pressure reducing member disposed between the high pressure separator 1 and the low pressure separator 8, and the pressure reducing component comprises at least one pressure reducing member 5 including a valve body, a valve chamber formed in the valve body, a valve seat 5-7 provided in the valve chamber, and a valve core 5-4 extending into the valve chamber and cooperating with the valve seat 5-7 to adjust the size of the fluid passage; the pressure reducing member further comprises at least one regulating member 11 including an adjustment medium outlet section 11-1 through which the valve body and the valve seat 5-7 are communicate with the valve chamber.

In the above-mentioned pressure reducing system, at least one regulating member 11 is provided, and the regulating member includes an adjustment medium outlet section 11-1 through which the valve body and the valve seat 5-7 communicate with the valve chamber. The outlet end of the adjustment medium outlet section is arranged on the valve seat 5-7, which introduces the adjustment medium into the top end of the inner cavity of the valve seat 5-7 and the valve core 5-4, in order to raise the pressure at this point, so as to migrate the tendency that the pressure at this point stays lower than the pressure of the saturated vapor pressure of the fluid, during the process of during the rapid fluid decompression, and reduce the level of erosion and wear to the valve core 5-4 and the valve seat 5-7 due to bubble burst and cavitation caused by the cavitation phenomenon; and the proportion of the adjustment medium and fluid is regulated to prevent the pressure reducing member 5 from losing the ability to adjust the fluid flow due to the formation of blocking flow caused by high temperature, high pressure, and high solid content fluid.

On the basis of the above-mentioned technical scheme, the regulating medium outlet section 11-1 is inclined toward the flow direction of the fluid, and the outlet end of the regulating medium outlet section 11-1 is provided on the valve seat 5-7 adjacent to the valve core 5-4, which forms convection with the fluid, and reduces its erosion and wear to the valve core 5-4 and the valve seat 5-7. Meanwhile, the outlet end is located near the valve core 5-4, which can reduce the level of erosion and wear toward the top end of the valve core 5-4 caused by the fluid, slow down the flow rate of the fluid, and thereby reducing the level of erosion and wear toward the valve seat 5-7 caused by the fluid.

On the basis of the above-mentioned technical scheme, the regulating member 11 further comprises a second flush valve 10 in communication with the regulating medium outlet section 11-1. In the present embodiment, as shown in FIG. 2, the second flush valve 10 is a steam valve, and the stir and vibration effect of the atomized steam is utilized, so as to ensure when the asphaltene of the hot high-pressure separator passes through a micro-pore (pore size of 3-5 mm) in the pressure reducing member 5, it will differentiates and diffuses into liquid drop, so as to coat the catalyst solid particles; and the steam can also clean the pressure reducing member 5 in order to prevent impurity from being deposited, coking and blocking the flow passage. In another embodiment, the second flush valve 10 is a nitrogen gas seal valve for purging the nitrogen after the valve has been repaired. A pressure gauge is installed on the nitrogen pipeline line connected to the nitrogen seal valve.

On the basis of the above-mentioned technical scheme, the regulating medium is asphaltenes and the temperature of the asphaltenes should control from 180° to 220° C. The temperature of the asphaltene is relevant to its components and the temperature of the hot high-pressure separator fluid; the pressure of the regulating medium of the adjustment member 11 is 20 Bar to 30 bar, the pressure of the asphaltene is relevant to the constant pressure of the hot low-pressure separator safety valve. When hot low-pressure separator safety valve adjusts its constant pressure, the pressure of the asphaltene will adjust therewith; in the technical scheme, the pressure of the asphaltene is specifically to the conventional hot low-pressure separator; the flow rate ratio of the regulating medium to the hot high-pressure separator in the high pressure separator is (0.8-1.2):10. By the above-mentioned technical solution, an appropriate viscosity of the asphaltenes ca be achieved. When the asphaltenes is mixed with the fluid, it may adsorb the catalyst particles in the fluid, in particular, the surface of the hard catalyst particles can be covered by the asphaltene, thereby slowing the erosion caused by the rapid scour toward the valve core 5-4 and the valve seat 5-7; by controlling the ratio between the outlet pressure and the flow rate, the hot high-pressure separator flow rate can be flexibly regulated. Of course, the regulating medium is not limited to asphaltenes, but other low-pressure oil that has suitable viscosity may also be used, such as the decompressed bottom oil of the hydrogenation suspension bed, atmospheric pressure bottom oil of the hydrogenation suspension bed, vacuum residuum or atmospheric pressure residual oil and so on.

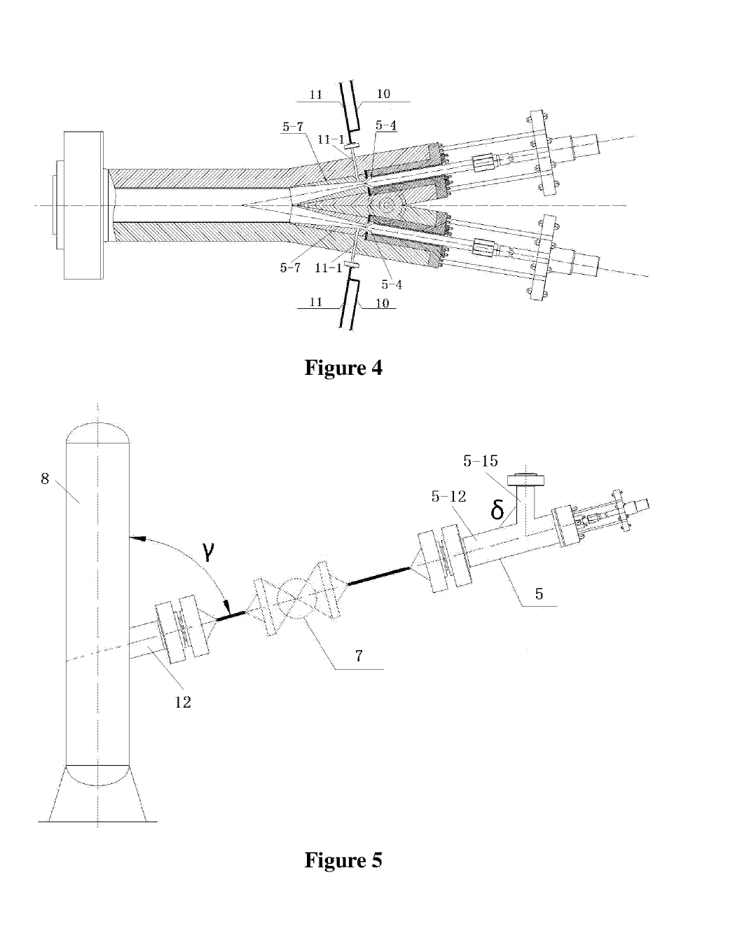

On the basis of the above-mentioned technical scheme, as shown in FIG. 4, the pressure reducing member 5 further comprising an inlet section 5-15 communicating with an inlet of the pressure reducing member and an outlet section 5-12 communicating with an outlet of the pressure reducing member. Through the setting there will be no deposition and coking for the solid content within the valve chamber, and along the direction of the fluid flow, wherein the inner cavity of the valve seat 5-7 comprises a flow reducing section and a flow increasing section, the movable end of the valve core 5-4 cooperating with the flow reducing section for regulating the flow rate or closing the fluid passage.

Preferably, the axial direction of the outlet section 5-12 of the pressure reducing member 5 is set to be perpendicular to the axial direction of the inlet section 5-15 of the pressure reducing member 5, or an axial direction of the outlet section 5-12 of the pressure reducing member 5 and the inlet section 5-15 of the pressure reducing member 5 intersect to form an angel 6 that is greater than 90°, which may prevent the solid content from being deposited and coking within the valve chamber.

It is to be noted that the pressure reducing member 5 can be a pressure reducing valve disclosed in the prior art, such as an angle type pressure reducing valve. In the present embodiment, a particularly preferred pressure reducing valve is shown in FIG. 4, comprising a main valve body having a valve chamber formed therein; the main valve body is having an outlet and an inlet connected with the valve chamber; two branch valves in which a branch valve body is connected with the main valve body; the branch valve body in which the branch valve chamber is formed to be connected with the valve chamber; and a valve core 5-4 slidably disposed in the branch valve chamber for regulating flow rate or closing a fluid passage between the valve inlet and the valve outlet. The branch valve chamber is formed a flow reducing section and a flow increasing section, flow reducing section is communicated with the valve inlet, the flow increasing section is communicated with the smaller opening end of the flow reducing section, and the larger opening end of the flow increasing section is communicated with the valve outlet. More preferably, the axis of the branch valve chamber and an axis of the valve outlet intersect to form an angle α of 5° to 30°; the axes of each two adjacent branch valve chambers intersect to form an angle β of 10° to 60°. By the use of the above-described structure of the pressure reducing valve has played a dual purpose of each other, when any one of the valve core 5-4 or valve seat 5-7 has a wear situation, and under the circumstance of not starting backup pipeline, no disturbance switch to a different valve can be achieved, and the spare valve core 5-4 and valve seat 5-7 for reducing pressure can be used.

On the basis of the above-mentioned technical scheme, wherein the outlet section of the pressure reducing member 5 and the low pressure separator intersect to form an axial angle γ of 70° to 80°, which prevents the solid from being deposited and coked in the pipeline, and the fluid diffuses by relying on its tilted impact force and contacts the bottom medium of the low pressure separator to create a perturbation to the bottom medium, and to prevent solid from being deposited and coking in the bottom media; meanwhile, it also slows down the level of impact caused by the fluid to the internal of the low pressure separator and extends the service cycle of the low pressure separator.

The ratio of diameters of the inlet section and the outlet section is not great than 0.5. Because of the fluid is at its saturation condition before decompression, the decompressed fluid gasification rate is about 40%˜60%. By setting the above diameter ratio, it is ensured that the gas-liquid mixed-phase flow rate and the liquid-phase flow rate are within a reasonable range, and balance the degree of anti-wear and anti-deposition.

On the basis of the above-mentioned technical scheme, the pressure reducing system comprises more than two pressure reducing members 5 and more than two regulating members 11, wherein, the regulating members are arranged to respectively correspond to respective one of the pressure reducing members, the pressure reducing member and the high pressure separator 1 has a diversion valve 3 disposed therebetween, the diversion valve 3 comprises at least one inlet and more than two outlets, and the outlets are arranged to respectively correspond to respective one of the pressure reducing members.

A first flush valve 9 is communicated with the diversion valve 3 to flush impurities within the diversion valve; in the present embodiment, as shown in FIG. 1, the diversion valve 3 is a three-way valve that has one inlet and two outlets, in which the three-way valve has two independent valve core, and two independent valve seats that share one valve body; the first flush valve 9 is a flush oil valve, and three of them are provided to flush the deposited solid content in the valve core and the bottom of the valve body of the three-way valve respectively, which reduces the dead corner for the solid particle media within the three-way valve, which prevents solid content from being deposited and coking;

At least one hot low-pressure separator inlet section 12 is connected to the inner cavity of the low pressure separator 8 and tilt setting on the low pressure separator 8, wherein the hot low-pressure separator inlet section 12 and the low pressure separator intersect to form an axial angle γ of 70° to 80°; the first stop valve 4 is disposed between the outlet of the diversion valve and the pressure reducing member; The pressure reducing system also comprises a second stop valve 7, wherein the inlet of the second stop valve 7 is communicated with the outlet of the pressure reducing member 5, the outlet of the second stop valve 7 is communicated with the low pressure separator 8, in which the outlet section 5-12 of the pressure reducing member 5, the second stop valve 7, and the hot low-pressure separator inlet section 12 of the low pressure separator 8 are coaxially provided. The second stop valve 7 can be a manual stop valve, such as ball valve without dead-corner, brake valve, and butterfly hamper etc.

On the basis of the above-mentioned technical scheme, adjacent two low heat inlet sections intersect to form an angle not greater than 60°, which can effectively reduce the angular range of the hot low-pressure separator anti-shock plate.

On the basis of the above-mentioned technical scheme, the pressure reducing system further comprises a first stop valve 4, which includes an outlet, and the outlet is in direct communication with the inlet of the pressure reducing member 5.

The outlet of the first stop valve 4 is in direct communication with the inlet of the pressure reducing member 5. The stop valve can be used to achieve the fluid on-off, and keep direct communication without any intermediate pipe, so that it will not cause solid particles to coke and block the pipeline by scouring the pipeline. The first stop valve 4 may be in the form of an angle valve, a ball valve, a brake valve or a butterfly valve, in which no dead zone is required and no solid particles can be accumulated; the direct communication may be selected from the means known in the prior art, such as welding, flange vertical connection or Grayloc connection.

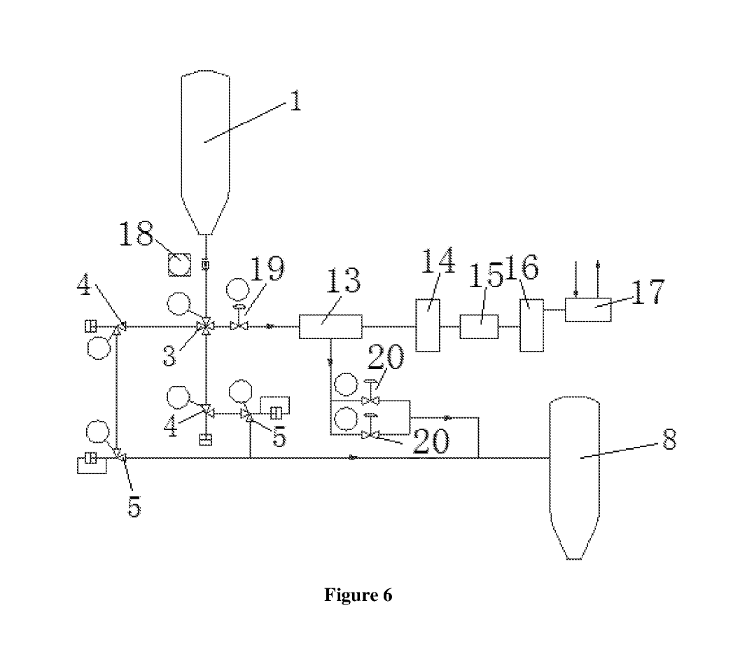

It should be noted that, in one embodiment, as shown in FIG. 1, a pressure reducing system comprises a high pressure separator 1 and a diversion valve 3, in which two routes are arranged in parallel, and each route is composed of a first pipeline 2, a first stop 4, pressure reducing member, a second pipeline 6, a second stop valve 7 and low pressure separator 8; as shown in FIG. 6, in another embodiment, three routes are arranged in parallel through a diversion valve 3, two routes of which include high pressure separators 1, flowmeters 18, diversion valves 3, first pipelines 2, first stop valves 4, pressure reducing members 5, adjustment members 11, second pipelines 6 and low pressure separators 8. Another route is composed of a high pressure separator 1, a flowmeter 18, a diversion valve 3, a first pipeline 2, a first control valve 19, a hydraulic turbine device 13, a second control valve 20, a second pipeline 6 and a low pressure separator. As shown in FIG. 6, the hydraulic turbine device 13 is connected with clutch 14, motor 15, transmission 16 and high pressure pump 17 successively. Alternatively, the hydraulic turbine device can be directly connected to high pressure pump 17, or successively connected to motor 15 and high pressure pump 17. Wherein the first control valve can be a flow controlled valve, the second control valve can be a pressure controlled valve. The fluid with steady flow or small fluctuations fluid through the hydraulic turbine device and the motor together for the high-pressure pump to provide power, to adjust the opening of the pressure reducing member 5 to ensure the stability of the hot high-pressure separator liquid level.

On the basis of the above-mentioned technical scheme, the pressure reducing system further comprises a first flush valve 9 communicated with the diversion valve 3 to flush impurities within the diversion valve 3; a thermal barrier coating and a wear resistant coating, successively disposed on a connecting pipe between the high pressure separator and the pressure reducing member, an inner wall of the connecting pipe between the pressure reducing member and the low pressure separator 8, and an inner wall of the low pressure separator 8. Of course, it may also be provided on other parts that require insulation and wear within the pressure reducing system, such as the inlet section 5-15 of the pressure reducing member 5 and on the inner wall of the outlet section 5-12. Through the above-mentioned thermal barrier coating and wear-resistant coating, the amount of thermal expansion can be reduced, the vibration can be slowed down, for example, the hot low-pressure separator thermal expansion can be reduced, the displacement of the pipeline spring can be reduced, the spring stiffness can be increased, the thermal expansion of the pipeline can be reduced and the amount of spring offset caused by thermal expansion can also be reduced.

It should be noted that, the thermal barrier coating and the wear resistant coating may be selected from those known in the art as resistant to high temperature and wear resistant materials, such as the tetragonal lattice yttrium stabilized zirconia can be selected, and sprayed into the place where it is to be treated by atmospheric plasma. The tetragonal lattice-stabilized zirconia has the following advantages:
1) the thermal conductivity reaches as low as about 1.5 W/(m*K), which can effectively block heat conduction;
2) the thermal expansion coefficient reaches as high as about 13*10⁻⁶ m/° C., which is basically the same as the thermal expansion coefficient of stainless steel, under operating conditions, and the thermal expansion and contraction performance of the substrate can be kept consistent;
3) the fracture toughness can be relatively high, so that no layer fracture will be caused under the high temperature conditions;
4) the thermal shock resistance can be high, so that it may ensure that no layer fracture will be caused by thermal shock cracking under high temperature conditions.

The actuators of the three-way valve, the stop valve, and the pressure reducing valve can be pneumatic, hydrodynamic, or electric, and are also known to those skilled in the art and will not be described here.

As a preferred embodiment, the pressure reducing member is the pressure reducing valve in the first embodiment.

It is obvious that the above-described embodiments are merely illustrative of the examples given and are not intended to be limiting of the embodiments. It will be apparent to those skilled in the art that various other changes or variations may be made by those skilled in the art on the basis of the above description. There is no need and no exhaustion of all the implementation. And the obvious changes or variations thus recited are still within the scope of protection created by the present invention.

1. A pressure reducing valve, comprising:
a main valve body, having a valve chamber formed therein, and also having a valve outlet and a valve inlet which are disposed thereon and respectively communicated with the valve chamber; and
at least two pressure reducing devices, disposed between the valve inlet and the valve outlet, and adapted for depressurizing fluid at the valve inlet before discharging to the valve outlet.

2. The pressure reducing valve according to claim 1, wherein the pressure reducing device comprises:
a branch valve body, connected to the main valve body,
a branch valve chamber formed in the branch valve body and in communication with the valve chamber, and
a valve core, slidably disposed in the branch valve chamber for regulating flow rate or closing a fluid passage between the valve inlet and the valve outlet.

3. The pressure reducing valve according to claim 1, wherein the main valve body is integrally formed with the branch valve body.

4. The pressure reducing valve according to claim 3, wherein the branch valve chamber is formed with a flow reducing section and a flow increasing section, the flow reducing section is communicated with the valve inlet, the flow increasing section is communicated with a smaller opening end of the flow reducing section, and a larger opening end of the flow increasing section is communicated with the valve outlet.

5. The pressure reducing valve according to claim 4, wherein the branch valve body comprises
a body having a tubular passage formed therein, and
a valve seat is disposed coaxially in the tubular passage close to one side of the valve outlet, an inner cavity of the valve seat comprises the smaller opening end of the flow reducing section and the flow increasing section which cooperate with a remaining section of the tubular channel to form the branch valve chamber, wherein, the valve core is slidable within the tubular passage and a movable end of the valve core cooperates with the smaller opening end of the flow reducing section for regulating the flow or closing the fluid passage.

6. The pressure reducing valve according to claim 5, further comprising an adjustment mechanism detachably connected to the valve core, wherein, the adjustment mechanism is adapted for driving the valve core to slide axially along the branch valve chamber to adjust a gap formed between the valve core and the valve seat for regulating fluid flow.

7. The pressure reducing valve according to claim 6, wherein an axis of the branch valve chamber and an axis of the valve outlet intersect to form an angle α of 5° to 30°, and
axes of each two adjacent branch valve chambers intersect to form an angle β of 10° to 60°.

8. The pressure reducing valve according to claim 6, further comprising
an inlet flow passage communicated with the valve inlet, with an axis of the inlet flow passage being perpendicular to an axis of the valve outlet, and
an outlet flow passage communicated with the pressure reducing device and the valve outlet;
wherein, the ratio of the inner diameter of the outlet flow passage to the inner diameter of the inlet flow passage is greater than one.

9. The pressure reducing valve according to claim 6, wherein the valve core and the branch valve chamber also have a guide sleeve disposed therebetween, and the valve core is slidable within the guide sleeve in a sealed manner.

10. The pressure reducing valve according to claim 8, wherein an inner surface of the outlet flow passage and the branch valve body, an outer surface of the valve core, and an inner wall of the inner cavity of the valve seat are respectively provided with a wear layer.

11. A pressure reducing system, comprising:
a high pressure separator, a low pressure separator, and at least one pressure reducing member disposed between the high pressure separator and the low pressure separator,
wherein the pressure reducing component comprises at least one pressure reducing member including a valve body, a valve chamber formed in the valve body, a valve seat provided in the valve chamber, and a valve core extending into the valve chamber and cooperating with the valve seat to adjust the size of the fluid passage,
wherein the pressure reducing member further comprises,
at least one regulating member including an adjustment medium outlet section, through which the valve body and the valve seat are communicated with the valve chamber.

12. The pressure reducing system according to claim 11, wherein the regulating medium outlet section is inclined toward a flow direction of the fluid, and an outlet end of the regulating medium outlet section is provided on the valve seat adjacent to the valve core.

13. The pressure reducing system according to claim 11, wherein the adjusting member further comprises a second flush valve in communication with the regulating medium outlet section.

14. The pressure reducing system according to claim 11, wherein the regulating medium is asphaltenes and the temperature of the asphaltenes is 180° C. to 220° C., and the pressure of asphaltene in the adjusting member is 20 bar to 30 bar, and
Wherein the flow rate ratio of the regulating medium to the hot high-pressure separator in the high pressure separator is (0.8-1.2):10.

15. The pressure reducing system according to claim 11, wherein the inner cavity of the valve seat comprises a flow reducing section and a flow increasing section, a movable end of the valve body cooperates with the flow reducing section for regulating the flow rate or closing the fluid passage.

16. The pressure reducing system according to claim 15, wherein an axial direction of the outlet section of the pressure reducing member is set to be perpendicular to an axial direction of the inlet section of the pressure reducing member, the outlet section and the low pressure separator intersect to form an axial angle γ of 70° to 80°, and
the ratio of diameters of the inlet section and the outlet section is not great than 0.5.

17. The pressure reducing system according to claim 16, further comprising more than two pressure reducing members and more than two regulating members, wherein, the regulating members are arranged to respectively correspond to respective one of the pressure reducing members, the pressure reducing member and the high pressure separator has a diversion valve disposed therebetween, the diversion valve comprises at least one inlet and more than two outlets, and the outlets are arranged to respectively correspond to respective one of the pressure reducing members.

18. The pressure reducing system according to claim 17, further comprising a first stop valve disposed between the outlet and the pressure reducing member, and
further comprising a second stop valve, an inlet of which is in communication with an outlet of the pressure reducing member, while an outlet of which is in communication with the low pressure separator, wherein, an outlet section of the pressure reducing member, the second stop valve and a low heat inlet section if the low pressure separator are disposed co axially.

19. The pressure reducing system according to claim 17, characterized in that adjacent two low heat inlet sections intersect to form an angle not greater than 60°, and an outlet of the first stop valve is in direct communication with an inlet of the pressure reducing member.

20. The pressure reducing system according to claim 19, further comprising:
a first flush valve communicated with the diversion valve to flush impurities within the diversion valve;
a thermal barrier coating and a wear resistant coating, successively disposed on a connecting pipe between the high pressure separator and the pressure reducing member, an inner wall of the connecting pipe between the pressure reducing member and the low pressure separator, and an inner wall of the low pressure separator.
